(19) United States
(12) Patent Application Publication
(10) Pub. No.: US 2011/0156507 A1
(43) Pub. Date: Jun. 30, 2011

(54) Hub Motor

(75) Inventors: Kou-Tzeng Lin, Zhudong Township (TW); Chin-Hone Lin, Puli Township (TW); Chi-Hau Ho, Hukou Township (TW)

(73) Assignee: INDUSTRIAL TECHNOLOGY RESEARCH INSTITUTE, Hsinchu (TW)

(21) Appl. No.: 12/964,064

(22) Filed: Dec. 9, 2010

(30) Foreign Application Priority Data
Dec. 24, 2009 (TW) 98144854

(51) Int. Cl. H02K 9/02; H02K 9/20

(52) U.S. Cl. 310/54; 310/59

(57) ABSTRACT

A hub motor is provided. The hub motor includes a shaft, a casing, a first bimetal, and a second bimetal. The casing has an inner wall, a first through hole, and a second through hole. The first through hole and the second through hole are disposed on the inner wall. The first bimetal and the second bimetal are disposed on the inner wall. A first end of the first bimetal, after being heated, warps and exposes the first through hole. A second end of the second bimetal, after being heated, warps and exposes the second through hole. The first end faces substantially the same direction as the rotating direction of the casing. The second end faces substantially the reverse direction of the rotating direction of the casing.

This application claims the benefit of Taiwan application Serial No. 98144854, filed Dec. 24, 2009, the subject matter of which is incorporated herein by reference.

### BACKGROUND

1. Technical Field

The disclosure relates in general to a hub motor, and more particularly to a hub motor with bimetal.

2. Description of the Related Art

Hub motor may be disposed on the vehicle. After electricity is conducted to the hub motor, the casing of the hub motor is rotated for driving the wheels of the vehicle.

The rotor of the hub motor, being rotated by the electromagnetic induction between the rotor and the coil, drives the casing of the hub motor to rotate. There is a gap between the rotor and the coil. In general, the smaller the gap, the better the electromagnetic effect, and the less the power consumption as well. In addition, the hub motor is almost sealed and the interior heat is hard to be dissipated to the exterior. When the temperature of the electromagnet reaches 150° C. or above, the magnetism of the electromagnet declines, deteriorating the electromagnetic induction between the rotor and the coil. Therefore, the cooling mechanism is essential to the hub motor.

Normally, the cooling mechanism of the hub motor introduces an exterior airflow to bring the interior heat away from the hub motor. The heat generated by the coil and the electromagnet is carried away through cooling passage and the gap between the rotor and the coil. To assure the cooling effect, the gap between the rotor and the coil must be big for allowing more airflow passing through and carrying more heat away. However, the bigger the gap, the poorer the electromagnetic effect, and the larger the power consumption. Moreover, the exterior airflow normally carries impurities, which may be attached on the electromagnet and the coil and result in friction between the electromagnet and the coil, hence reducing the lifespan of the hub motor.

### SUMMARY

The disclosure is directed to a hub motor. Through the disposition of a bimetal, which warps and exposes a through hole when the interior temperature of the hub motor reaches a predetermined temperature, the interior heat of the hub motor is dissipated to the exterior.

According to a first aspect of the present disclosure, a hub motor is provided. The hub motor includes a shaft, a casing, a first bimetal, a second bimetal, a rotor, and a stator. The casing has an inner wall, a first through hole, and a second through hole. The first through hole and the second through hole are disposed on the inner wall. The rotor and the casing are fastened and rotated together, the stator is fastened on the inner shaft. The first bimetal and the second bimetal are disposed on the inner wall. A first end of the first bimetal, after being heated, warps and exposes the first through hole. A second end of the second bimetal, after being heated, warps and exposes the second through hole. The first end faces substantially the same direction as the rotating direction of the casing. The second end faces substantially the reverse direction of the rotating direction of the casing.

The above and other aspects of the disclosure will become better understood with regard to the following detailed description of the non-limiting embodiment(s). The following description is made with reference to the accompanying drawings.

### BRIEF DESCRIPTION OF THE DRAWINGS

FIG. 1 shows an explosion diagram of a hub motor according to a first embodiment of the disclosure;

FIG. 2 shows a schematic diagram of a first casing of FIG. 1 viewed in direction V1;

FIG. 3 shows a cross-sectional diagram viewed along direction 3-3′ of FIG. 2;

FIG. 4 shows an enlarged diagram of a first bimetal of FIG. 3;

FIG. 5 shows a schematic diagram of a cooling fin of FIG. 1;

FIG. 6 shows a top view of the cooling fin of FIG. 5;

FIG. 7 shows an assembly diagram of the cooling fin and the inner shaft of FIG. 5;

FIG. 8 shows a partial diagram of a first casing of the hub motor according to a second embodiment of the disclosure;

FIG. 9 shows a schematic diagram of a first casing of a hub motor according to a third embodiment of the disclosure;

FIG. 10 shows a schematic diagram of a first casing of a hub motor according to a fourth embodiment of the disclosure; and

FIG. 11 shows a schematic diagram of a first casing of a hub motor according to a fifth embodiment of the disclosure.

### DETAILED DESCRIPTION

### First Embodiment

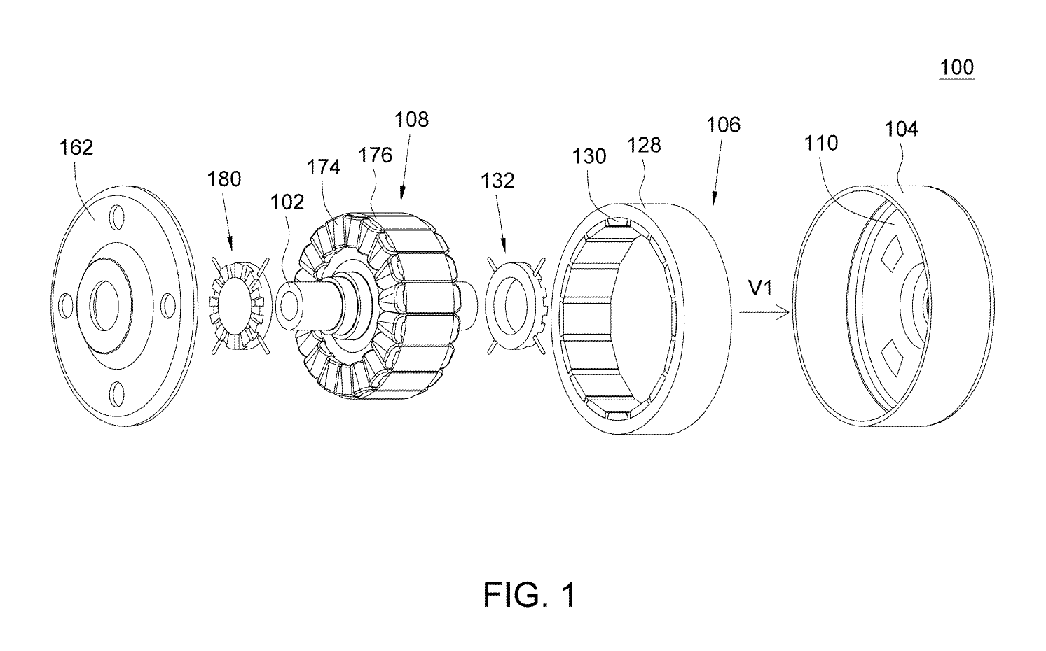

Referring to FIG. 1, an explosion diagram of a hub motor according to a first embodiment of the disclosure is shown. The hub motor 100 includes a shaft 102, a first casing 104, a second casing 162, a rotor assembly 106, cooling fins 132 and 180, and a stator assembly 108.

The stator assembly 108 is fastened on the shaft 102, and includes a coil 174 and a silicon steel sheets 176 for winding the coil 174. The stator assembly 108 is adjacent to the rotor assembly 106.

The rotor assembly 106 includes an outer rotor 128 formed by silicon steel sheets, and several sets of electromagnets 130 disposed on the inner side wall of the outer rotor 128. The rotor assembly 106 and the stator assembly 108 are co-axial, and after the first casing 104, the stator assembly 108, and the rotor assembly 106 are assembled, a gap is formed between the silicon steel sheets 176 of the stator assembly 108 and the electromagnet 130 of the rotor assembly 106.

The outer rotor 128 of the rotor assembly 106 is fixed on the first casing 104, and the first casing 104 is fixed on the second casing 162. Once the electricity is conducted to the stator assembly 108, the rotor assembly 106 is rotated due to electromagnetic induction, and further drives the first casing 104 and the second casing 162 to rotate.

The cooling fin 132 is adjacent to the inner wall 110 of the first casing 104, which is mounted on the shaft 102. The cooling fin 180 is adjacent to the inner wall 110 of the second casing 162, which is mounted on the shaft 102. The cooling fins 132 and 180 may receive the heat generated by the coil 174 being electrified, and further convect the interior heat to the exterior. The convection of the heat will be further elaborated in the disclosure of the cooling fin.

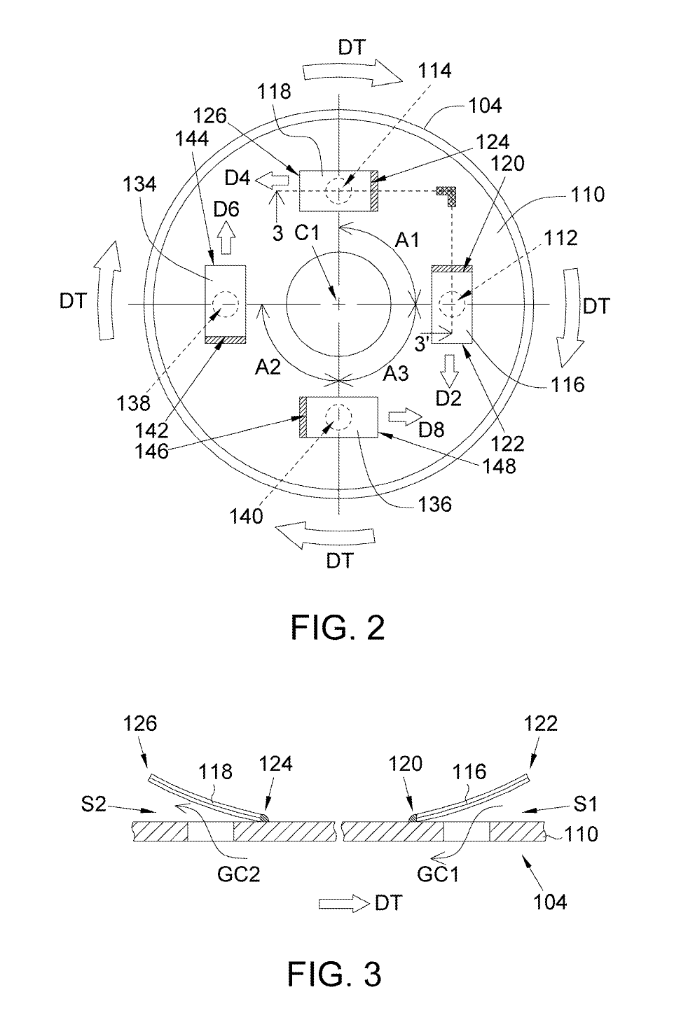

Referring to FIG. 2, a schematic diagram of a first casing of FIG. 1 viewed in direction V1 is shown. The first casing 104, which may be mounted by the shaft 102 penetrating through a bearing, has a first through hole 112, a second through hole 114, a third through hole 138, and a fourth through hole 140. The first through hole 112, the second through hole 114, the third through hole 138, and the fourth through hole 140 have a diameter of such as 20 millimeters (mm), pass through the inner wall 110, and connect the interior of the hub motor 100 to the exterior for dissipating the interior heat of the hub motor 100 to the exterior through the first through hole 112, the second through hole 114, the third through hole 138, and the fourth through hole 140. The cooling mechanism of the hub motor 100 using bimetal is disclosed below.

The hub motor 100 further includes a first bimetal 116, a second bimetal 118, a third bimetal 134, and a fourth bimetal 136.

The first bimetal 116 has a third end 120 and a first end 122 opposite to the third end 120, wherein the third end 120 is adjacent to the first through hole 112 and fixed on the inner wall 110. The first bimetal 116 selectively shields or exposes the first through hole 112. Furthermore, the first end 122, after being heated, warps and exposes the first through hole 112.

The second bimetal 118 has a fourth end 124 and a second end 126 opposite to the fourth end 124, wherein the fourth end 124 is adjacent to the second through hole 114 and fixed on the inner wall 110. The second bimetal 118 selectively shields or exposes the second through hole 114. Furthermore, the second end 126, after being heated, warps and exposes the second through hole 114.

The third bimetal 134 has a seventh end 142 and a fifth end 144 opposite to the seventh end 142, wherein the seventh end 142 is adjacent to the third through hole 138 and fixed on the inner wall 110. The third bimetal 134 selectively shields or exposes the third through hole 138. Furthermore, the fifth end 144, after being heated, warps and exposes the third through hole 138.

The fourth bimetal 136 has an eighth end 146 and a sixth end 148 opposite to the eighth end 146, wherein the eighth end 146 is adjacent to the fourth through hole 140 and fixed on the inner wall 110. The fourth bimetal 136 selectively shields or exposes the fourth through hole 140. Furthermore, the sixth end 148, after being heated, warps and exposes the fourth through hole 140.

The third end 120, the fourth end 124, the seventh end 142, and the eighth end 146 are fixed on the first casing 104 by way of soldering.

The heat is generated inside the hub motor 100 when the first casing 104 is rotated. After being heated, the first bimetal 116, the second bimetal 118, the third bimetal 134, and the fourth bimetal 136 respectively warp and expose the first through hole 112, the second through hole 114, the third through hole 138, the fourth through hole 140, so that an airflow is induced between the exterior and the interior of the hub motor 100 through the first through hole 112, the second through hole 114, the third through hole 138, the fourth through hole 140 for dissipating the interior heat of the hub motor 100 to the exterior.

Referring to FIG. 2, the direction D2 of the first end 122 of the first bimetal 116 faces substantially the same direction as the rotating direction DT of the first casing 104, and the direction D4 of the second end 126 of the second bimetal 118 faces substantially the reverse direction of the rotating direction DT of the first casing 104. The direction D2 of the first end 122 faces substantially the same direction as the rotating direction DT, that is, the direction D2 of faces substantially the same direction as the tangent velocity direction of the first end 122. The direction D4 of the second end 126 faces substantially the reverse direction of the rotating direction DT, that is, the direction D4 faces substantially the reverse direction of the tangent velocity direction of the second end 126.

Referring to FIG. 3, a cross-sectional diagram viewed along direction 3-3′ of FIG. 2 is shown. When the first bimetal 116 is heated, the first end 122 warps and exposes the first through hole 112 for dissipating the heat to the exterior through the first through hole 112 via the airflow GC1. Meanwhile, when the second bimetal 118 is heated, the second end 126 warps and exposes the second through hole 114 for allowing an exterior airflow GC2 to enter the first casing 104 through the second through hole 114. Thus, the interior of the hub motor 100 is cooled via the airflow GC1, which dissipates the heat to the exterior through the first through hole 112, and the airflow GC2, which enables exterior air to enter the hub motor 100 through the second through hole 114.

As indicated in FIG. 3, when the first casing 104 is rotated along the rotating direction DT, the space S1 generates a high pressure, and the space S2 generates a low pressure. The high pressure makes the airflow GC1 flow to the exterior from the interior of the hub motor 100, and at the same time dissipates the heat to the exterior from the interior of the hub motor 100. The low pressure makes the airflow GC2 flows from the exterior to the interior of the hub motor 100, and at the same time brings the exterior low-temperature air to the interior of the hub motor 100 for cooling the interior of the hub motor 100.

The direction D6 of the fifth end 144 of the third bimetal 134 faces substantially the same direction as the rotating direction DT of the first casing 104. The direction D8 of the sixth end 148 of the fourth bimetal 136 faces substantially the reverse direction of the rotating direction DT of the first casing 104. The direction D6 of the fifth end 144 faces substantially the same direction as the rotating direction DT, that is, the direction D6 faces substantially the same direction as the tangent velocity direction of the first end 144. The direction D8 of the sixth end 148 faces substantially the reverse direction of the rotating direction DT, that is, the direction D8 faces substantially the reverse direction of the tangent velocity direction of the sixth end 148. The theory of forming airflow with the third bimetal 134, the fourth bimetal 136, the third through hole 138, and the fourth through hole 140 is similar to that of forming the airflows GC1 and GC2 disclosed above, and the similarities are not repeated here.

Preferably but not limitedly, the first through hole 112, the second through hole 114, the third through hole 138, and the fourth through hole 140 may be uniformly distributed on the inner wall 110 for uniformly dissipating the interior heat of the hub motor 100 to the exterior. Again, referring to FIG. 2, the angle A1 contained between the first through hole 112 and the second through hole 114 with respect to the rotation center C1 is about 90 degrees. The angle A2 contained between the third through hole 138 and the fourth through hole 140 with respect to the rotation center C1 is 90 degrees. The angle A3 contained between the first bimetal 116 and the fourth bimetal 136 with respect to the rotation center C1 is about 90 degrees. However, the above exemplification is not for limiting the present embodiment of the disclosure. In another implementation, the angle contained the first bimetal 116 and the second bimetal 118 with respect to the rotation center C1 is a first angle, and the angle contained between the third bimetal 134 and the fourth bimetal 136 with respect to the rotation center C1 is a second angle, wherein the first angle is different from the second angle.

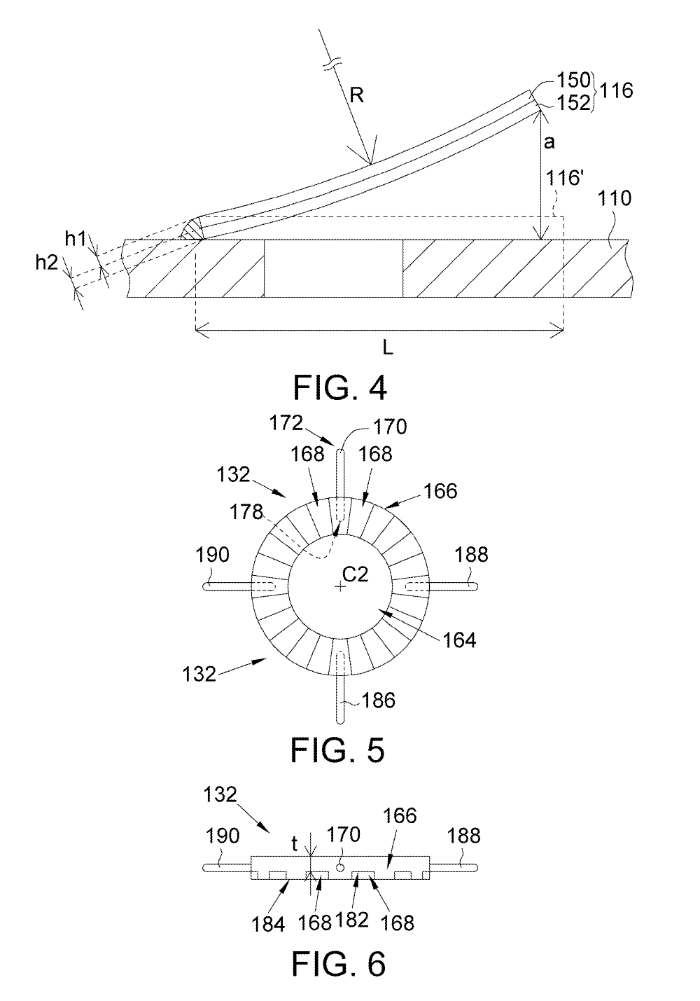

Besides, the cooling function of the hub motor 100 may be controlled by controlling the warpage degree of the first bimetal 116. Referring to FIG. 4, an enlarged diagram of a first bimetal of FIG. 3 is shown. The first bimetal 116 includes a first metal 150 and a second metal 152. The first metal 150 has a first thermal expansion coefficient α1. The second metal 152 is located between the first metal 150 and the inner wall 110, and has a second thermal expansion coefficient α2. The second thermal expansion coefficient α2 is larger than the first thermal expansion coefficient α1. For example, the second metal 152 may be formed by aluminum with a larger expansion coefficient, and the first metal 150 may be formed by invar or other kind of nickel iron alloy with a smaller expansion coefficient.

Before the first bimetal 116 is heated, the first metal 150 is substantially appressed on the inner wall 110 like the original state 116′ as indicated in FIG. 4. When the first bimetal 116 is heated, the first bimetal 116 is deflected and form an arc whose radius is R according to formulas (1), (2), and (3). The warpage a may be obtained according to the radius R, the material properties, and the size of the first bimetal 116.

$$\begin{matrix}ɛ = ( α2 - α1 ) Δ T & ( 1 ) \\ k = \frac{6 {E}_{2} {E}_{1} ( {h}_{2} + {h}_{1} ) {h}_{2} {h}_{1} ɛ}{{E}_{2}^{2} {h}_{2}^{4} + 4 {E}_{2} {E}_{1} {h}_{2}^{3} {h}_{1} + 6 {E}_{2} {E}_{1} {h}_{2}^{2} {h}_{1}^{2} + 4 {E}_{2} {E}_{1} {h}_{1}^{3} {h}_{2} + {E}_{1}^{2} {h}_{1}^{4}} & ( 2 ) \\ R = \frac{1}{k} & ( 3 )\end{matrix}$$

In formula (1), ΔT denotes temperature difference. In formula (2), E1 denotes Young's modulus of the first metal 150, E2 denotes Young's modulus of the second metal 152, h1 denotes the thickness of the first metal 150, and h2 denotes the thickness of the second metal 152. By adjusting the parameters E1, E2, h1, h2, Δ1, and α2, different degrees of warpage a may be obtained for controlling the cooling function of the hub motor 100.

Moreover, the second bimetal 118 includes a third metal (not illustrated) with a third thermal expansion coefficient α3 and a fourth metal (not illustrated) with a fourth thermal expansion coefficient α4. The fourth metal is located between the third metal and the inner wall. The fourth thermal expansion coefficient α4 is larger than the third thermal expansion coefficient α3.

The third bimetal 134 includes a fifth metal (not illustrated) with a fifth thermal expansion coefficient α5 and a sixth metal (not illustrated) with a sixth thermal expansion coefficient α6. The sixth metal is located between the fifth metal and the inner wall. The sixth thermal expansion coefficient α6 is larger than the fifth thermal expansion coefficient α5.

The fourth bimetal 136 includes a seventh metal (not illustrated) with a seventh thermal expansion coefficient α7 and an eighth metal (not illustrated) with an eighth thermal expansion coefficient α8. The eighth metal is located between the seventh metal and the inner wall. The eighth thermal expansion coefficient α8 is larger than the seventh thermal expansion coefficient α7.

The design of the warpage of the second bimetal 118, the third bimetal 134, and the fourth bimetal 136 is similar to that of the warpage volume of the first bimetal 116, and is not repeated here.

Referring to both FIG. 5 and FIG. 6. FIG. 5 shows a schematic diagram of a cooling fin of FIG. 1. FIG. 6 shows a top view of the cooling fin of FIG. 5. The cooling fin 132 may be formed by a material with excellent heat conduction such as aluminum or copper.

As indicated in FIG. 5, the cooling fin 132 is adjacent to the inner wall 110 and is mounted on the shaft 102 and has 12 recesses 168, an outer periphery surface 166, an inner hole 164 and a side surface 184 (illustrated in FIG. 6) connected to the inner hole 164. The side surface 184 connects the outer periphery surface 166 to the inner hole 164. The recesses 168 are located at the side surface 184 and penetrate to the inner hole 164 from the outer periphery surface 166, wherein a portion of the thickness t (illustrated in FIG. 6) is still reserved. However, the above exemplification is not for limiting the present embodiment of the disclosure. In other implementations, the recesses 168 do not penetrate to the inner hole 164, that is, there is a thickness between the recesses 168 and the inner hole 164, and an opening is exposed on the outer periphery surface 166. Alternatively, there is a thickness between the recesses 168 and the inner hole 164, and there is a thickness between the recesses 168 and the outer periphery surface 166.

Since the inner side wall 182 (illustrated in FIG. 6) of the recesses 168 of the present embodiment in the disclosure provides more dissipation area, more heat may be dissipated from the interior of the hub motor 100.

Preferably, the recesses 168 may face the inner wall 110, so that the thermal convection distance between the recesses 168 and the holes of the inner wall 110 may be shortened. However, the above exemplification is not for limiting the present embodiment in the disclosure. In an implementation, the recesses 168 may back on the inner wall 110.

Though the number of the recesses 168 is exemplified by 12 in the present embodiment in the disclosure, the number of the recesses 168 can be different from 12. For example, in an implementation, the number of the recesses 168 may be 36, and the contained angle between two adjacent recesses is about 10 degrees. Alternatively, the number of recesses 168 may be other than 12 and 36, and the contained angle between two adjacent recesses does not have to be identical.

The hub motor 100 further includes eight heat pipes, wherein four heat pipes 170, 186, 188, and 190 are disposed on the cooling fin 132, and the other four heat pipes are disposed on the cooling fin 180. Let the four heat pipes disposed on the cooling fin 132 be taken for example. The angle contained between two adjacent heat pipes is about 90 degrees with respect to the center C2 of the cooling fin 132 so that the heat pipe 170 and the heat pipe 186 are symmetrical with respect to the center C2, and the heat pipe 188 and the heat pipe 190 are symmetrical with respect to the center C2. The heat pipes symmetrically disposed may expand the area for receiving the heat, so that the heat is dissipated more uniformly. However, the above exemplification is not for limiting the present embodiment in the disclosure. In an implementation, the number of heat pipes may be odd-numbered, or, there is only one set of heat pipes symmetrically disposed.

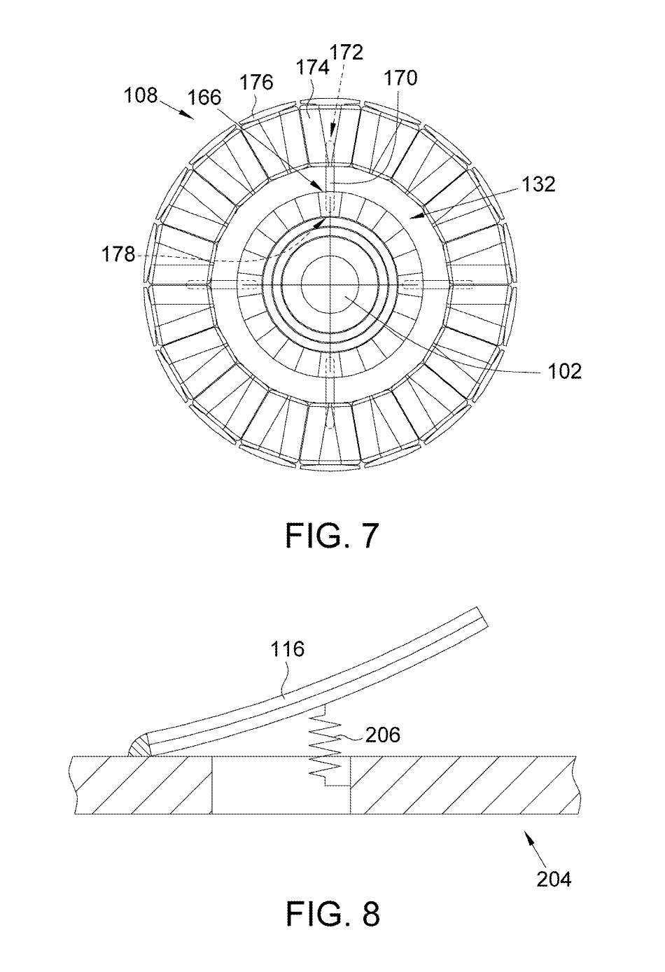

Referring to FIG. 7, an assembly diagram of the cooling fin and the shaft of FIG. 5 is shown. Let the heat pipe 170 be taken for example. An end 172 of the heat pipe 170 is projected from an outer periphery surface 166 and is extended to be connected to the coil 174 of the stator assembly 108, and the other end 178 may be embedded in the cooling fin 132. Thus, the heat of the coil 174 may be quickly conducted to the recesses 168 through the heat pipe 170 and convected to the air from the inner side wall 182 (the inner side wall 182 is illustrated in FIG. 6) of the recesses 168. The connection between the remaining heat pipes and the cooling fin 132 is similar to that of heat pipe 170, and the similarities are not repeated here.

Also, the structure of the cooling fin 180 is similar to that of the cooling fin 132, and the connection between the cooling fin 180 and the stator assembly 108 is similar to that between the cooling fin 132 and the stator assembly 108, and the similarities are not repeated here.

In the present embodiment of the disclosure, the hub motor 100 includes cooling fins 132 and 180. However, the above exemplification is not for limiting the present embodiment of the disclosure. In another implementation, the hub motor may do without cooling fins 132 and 180, and the heat inside the hub motor 100 still may be dissipated through the abovementioned bimetal.

In the present embodiment of the disclosure, the second casing 162 has a fifth through hole, a sixth through hole, a seventh through hole, and an eighth through hole (these through holes are not illustrated), and the hub motor 100 further includes a fifth bimetal, a sixth bimetal, a seventh bimetal, and an eighth bimetal. The structures and the connections of the through holes and the bimetals are similar to that of the first through hole 112, the second through hole 114, the third through hole 138, the fourth through hole 140, the first bimetal 116, the second bimetal 118, the third bimetal 134, and the fourth bimetal 136 of the first casing 104, and the similarities are not repeated here.

### Second Embodiment

Referring to FIG. 8, a partial diagram of a first casing of the hub motor according to a second embodiment of the disclosure is shown. As for the similarities between the second embodiment and the first embodiment, the same designations are used, and the similarities are not repeated here. The second embodiment is different from the first embodiment in that: the first casing 204 of the hub motor of the second embodiment further includes a first elastomer 206, a second elastomer (not illustrated), a third elastomer (not illustrated), and a fourth elastomer (not illustrated). The details of the first elastomer 206 are disclosed below as an exemplification.

The first elastomer 206 connects the first bimetal 116 to the first casing 204. When the temperature inside the hub motor is lower, the first bimetal 116 has only a small warpage. Thus, the elastic potential energy stored by the first elastomer 206 is sufficient to hold the first bimetal 116. Otherwise, the first bimetal 116 might wobble or strike the first casing 204.

When the temperature inside the hub motor is higher, the force generated by the first bimetal 116 due to warpage is larger than the elastic force of the first elastomer 206, so that the first bimetal 116 completely exposes the first through hole 112 and activates the energy dissipation mechanism of the hub motor.

Furthermore, with appropriate design of the spring constant of the first elastomer 206, the activation timing of the first bimetal 116 may be controlled so as to control the cooling properties of the hub motor.

Though the second elastomer, the third elastomer, and the fourth elastomer are not illustrated in FIG. 8, the second elastomer connects the second bimetal 118 to the first casing 204, the third elastomer connects the third bimetal 134 to the first casing 204, and the fourth elastomer connects the fourth bimetal 136 to the first casing 204. The design of the spring constants of the second elastomer, the third elastomer, and the fourth elastomer is similar to that of the first elastomer 206, and the similarities are not repeated here.

### Third Embodiment

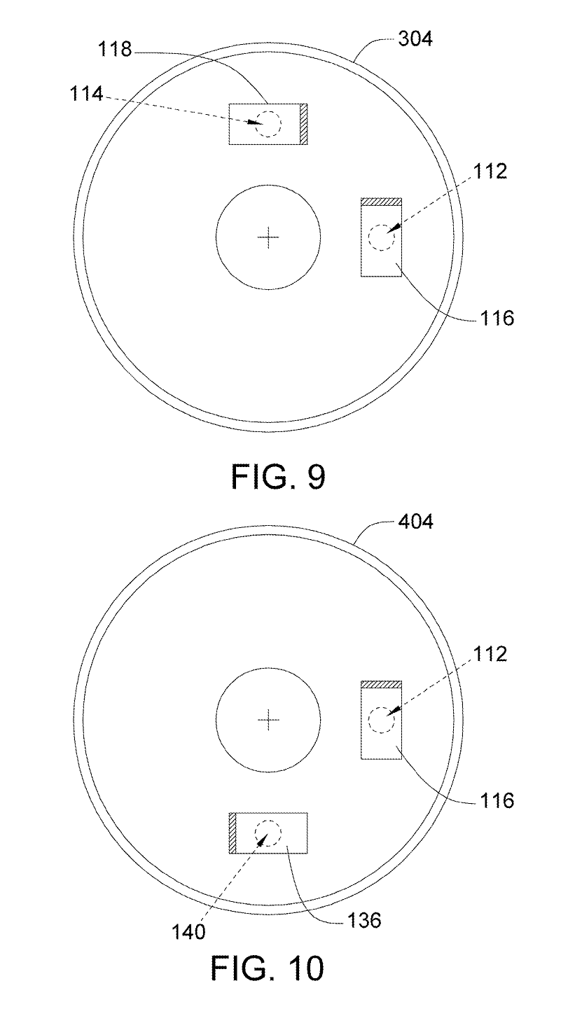

Referring to FIG. 9, a schematic diagram of a first casing of a hub motor according to a third embodiment of the disclosure is shown. As for the similarities between the third embodiment and the first embodiment, the same designations are used, and the similarities are not repeated here. The third embodiment is different from the first embodiment in that: the first casing 304 of the third embodiment has two holes and the hub motor has two pieces of bimetal.

Furthermore, the hub motor of the present embodiment of the disclosure may function properly without adopting the third through hole 138, the fourth through hole 140, the third bimetal 134, and the fourth bimetal 136 of the first embodiment. It keeps the first through hole 112, the second through hole 114, the first bimetal 116, and the second bimetal 118 only.

Though the hub motor of the present embodiment of the disclosure only has two pieces of bimetal, during the operation of the hub motor, an airflow still may be induced between the interior and the exterior of the hub motor through the first through hole 112 and the second through hole 114 for dissipating the heat generated inside the hub motor to the exterior. The theory of generating airflow is already disclosed in FIG. 3, and the similarities are not repeated here.

According to the theory of generating airflow as indicated in FIG. 3, the present embodiment of the disclosure may have many implementations, and two of the many implementations are exemplified in the fourth embodiment and the fifth embodiment below.

### Fourth Embodiment

Referring to FIG. 10, a schematic diagram of a first casing of a hub motor according to a fourth embodiment of the disclosure is shown. As for the similarities between the fourth embodiment and the first embodiment, the same designations are used, and the similarities are not repeated here. The fourth embodiment is different from the first embodiment in that: the first casing 404 of the hub motor of the present embodiment of the disclosure may function properly without adopting the second through hole 114, the third through hole 138, the second bimetal 118, and the third bimetal 134 of the first embodiment. It keeps the first through hole 112, the fourth through hole 140, the first bimetal 116, and the fourth bimetal 136 only.

### Fifth Embodiment

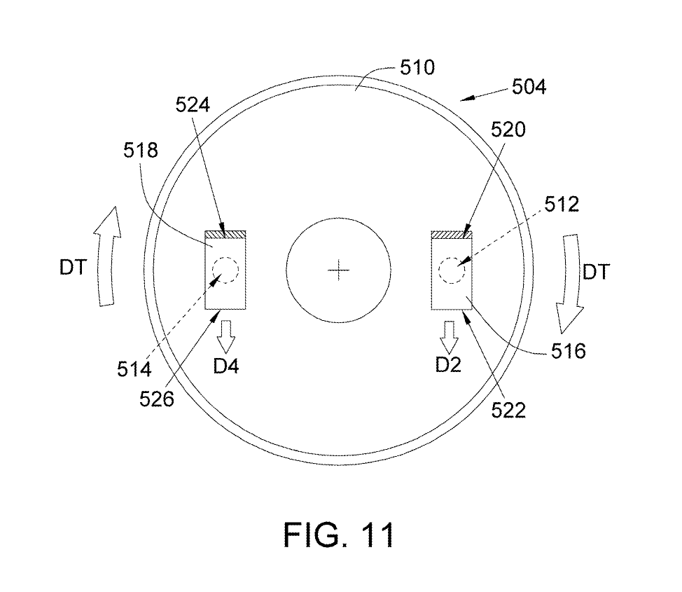

Referring to FIG. 11, a schematic diagram of a first casing of a hub motor according to a fifth embodiment of the disclosure is shown. As for the similarities between the fifth embodiment and the first embodiment, the same designations are used, and the similarities are not repeated here. The first casing 504 of the fifth embodiment has a first through hole 512 and a second through hole 514 which are symmetrically disposed, and the hub motor further includes a first bimetal 516 and a second bimetal 518.

The angle contained between the first bimetal 516 and the second bimetal 518 of the hub motor is about 180 degrees with respect to the rotation center C1.

The first bimetal 516 and the second bimetal 518 are disposed on the first casing 504. The first bimetal 516 has a third end 520 and a first end 522 opposite to the third end 520, wherein the third end 520 is adjacent to the first through hole 512 and fixed on the inner wall 510 of the first casing 504. The second bimetal 518 has a fourth end 524 and a second end 526 opposite to the fourth end 524, wherein the fourth end 524 is adjacent to the second through hole 514 and fixed on the inner wall 510. The direction D2 of the first end 522 of the first bimetal 516 faces substantially the same direction as the rotating direction DT of the first casing 504, and the direction D4 of the second end of the second bimetal 518 faces substantially the reverse direction of the rotating direction DT of the first casing 504.

According to the hub motor disclosed in the above embodiments of the disclosure, when the temperature inside the hub motor reaches a predetermined level, the bimetal warps and exposes the through hole, so as to dissipate the interior heat of the hub motor to the exterior. In addition, the hub motor may further includes cooling fins and heat pipes for dissipating more heat generated inside the hub motor.

As the disclosure described by way of example and in terms of the exemplary embodiment, it is understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hub motor comprising:
a shaft;
a casing having an inner wall, a first through hole, and a second through hole, wherein the first through hole and the second through hole are located at the inner wall;
a first bimetal disposed on the inner wall, wherein a first end of the first bimetal, after being heated, warps and exposes the first through hole;
a second bimetal disposed on the inner wall, wherein a second end of the second bimetal, after being heated, warps and exposes the second through hole;
a rotor assembly fixed on the casing for rotating the casing; and
a stator assembly disposed on the shaft;
wherein the first end of the first bimetal faces substantially the same direction as the rotating direction of the casing, and the second end of the second bimetal faces substantially the reverse direction of the rotating direction of the casing.

2. The hub motor according to claim 1, wherein the first bimetal further has a third end opposite to the first end, and the second bimetal further has a fourth end opposite to the second end;
wherein the third end of the first bimetal is fixed on the inner wall, and the fourth end of the second bimetal is fixed on the inner wall.

3. The hub motor according to claim 1, wherein the angle contained between the first through hole and the second through hole is substantially 90 degrees with respect to a rotation center.

4. The hub motor according to claim 1, wherein the angle contained between the first through hole and the second through hole is substantially 180 degrees with respect to a rotation center.

5. The hub motor according to claim 1, wherein the first bimetal comprises:
a first metal having a first thermal expansion coefficient; and
a second metal connected to the first metal and located between the first metal and the inner wall, wherein the second metal has a second thermal expansion coefficient being larger than the first thermal expansion coefficient; and
the second bimetal comprises:
a third metal having a third thermal expansion coefficient; and
a fourth metal connected to the third metal and located between the third metal and the inner wall, wherein the fourth metal has a fourth thermal expansion coefficient being larger than the third thermal expansion coefficient.

6. The hub motor according to claim 5, wherein the first metal and the third metal are both formed by nickel iron alloy, and the second metal and the fourth metal are both formed by aluminum.

7. The hub motor according to claim 1, further comprising:
a first elastomer connecting the first bimetal to the casing, wherein the first elastomer stores elastic potential energy when the first bimetal warps; and
a second elastomer connecting the second bimetal to the casing, wherein the second elastomer stores elastic potential energy when the second bimetal warps.

8. The hub motor according to claim 1, wherein the casing further has a third through hole and a fourth through hole, which are both disposed on the inner wall, and the hub motor further comprising:
a third bimetal disposed on the inner wall, wherein a fifth end of the third bimetal, after being heated, warps and exposes the third through hole;
a fourth bimetal disposed on the inner wall, wherein a sixth end of the fourth bimetal, after being heated, warps and exposes the fourth through hole;
wherein the fifth end of the third bimetal faces substantially the same direction as the rotating direction of the casing, and the sixth end of the fourth bimetal faces substantially the reverse direction of the rotating direction of the casing;
wherein the angle contained between the third through hole and the fourth through hole is substantially 90 degrees with respect to a rotation center, and the angle contained between the first through hole and the fourth through hole is substantially 90 degrees with respect to the rotation center.

9. The hub motor according to claim 8, wherein the third bimetal further has a seventh end opposite to the fifth end, and the fourth bimetal further has an eighth end opposite to the sixth end;
wherein the seventh end of the third bimetal is fixed on the inner wall, and the eighth end of the fourth bimetal is fixed on the inner wall.

10. The hub motor according to claim 8, further comprising:
a third elastomer connecting the third bimetal to the casing, wherein the third elastomer stores elastic potential energy when the third bimetal warps; and
a fourth elastomer connecting the fourth bimetal to the casing, wherein the fourth elastomer stores elastic potential energy when the fourth bimetal warps.

11. The hub motor according to claim 8, wherein the third bimetal comprises:
a fifth metal having a fifth thermal expansion coefficient; and
a sixth metal connected to the fifth metal and located between the fifth metal and the inner wall, wherein the sixth metal has a sixth thermal expansion coefficient being larger than the fifth thermal expansion coefficient; and
the fourth bimetal comprises:
a seventh metal having a seventh thermal expansion coefficient; and
an eighth metal connected to the seventh metal and located between the seventh metal and the inner wall, wherein the eighth metal has an eighth thermal expansion coefficient being larger than the seventh thermal expansion coefficient.

12. The hub motor according to claim 1, further comprising:
a cooling fin disposed adjacent to the inner wall.

13. The hub motor according to claim 12, wherein the cooling fin has a plurality of recesses, an inner hole and a side surface connected to the inner hole;
wherein the cooling fin is mounted on the shaft penetrating through the inner hole, and the recesses are located at the side surface.

14. The hub motor according to claim 13, wherein the cooling fin has an outer periphery surface, the side surface connects the outer periphery surface and the inner hole, and the recesses penetrate to the inner hole from the outer periphery surface.

15. The hub motor according to claim 12, wherein the stator assembly comprises a coil, and the hub motor further comprises:
a heat pipe, wherein an end of the heat pipe is connected to the coil, and the other end of the heat pipe is connected to the cooling fin.

16. The hub motor according to claim 13, wherein the stator assembly comprises a coil, and the hub motor further comprises:
a heat pipe, wherein an end of the heat pipe is connected to the coil, and the other end of the heat pipe is embedded in the cooling fin from the outer periphery surface.

17. The hub motor according to claim 12, wherein the stator assembly comprises a coil, and the hub motor further comprises:
a plurality of heat pipes, wherein an end of each heat pipe is connected to the coil, and the other end of each heat pipe is connected to the cooling fin;
wherein two of the heat pipes are symmetrically disposed.

18. The hub motor according to claim 12, wherein the cooling fin is formed by metal.

19. The hub motor according to claim 18, wherein the cooling fin is formed by aluminum or copper.
